(19) United States
(12) Patent Application Publication
(10) Pub. No.: US 2026/0071105 A1
(43) Pub. Date: Mar. 12, 2026

(54) REACTIVE POLYURETHANE HOT MELT ADHESIVE WITH IMPROVED ADHESION TO METALS

(71) Applicant: Henkel AG & Co. KGaA, Duesseldorf (DE)

(72) Inventors: Yingjie Li, Batavia, IL (US); Shuhui Qin, Palatine, IL (US)

(21) Appl. No.: 19/388,095

(22) Filed: Nov. 13, 2025

Related U.S. Application Data
(63) Continuation of application No. PCT/US2024/027722, filed on May 3, 2024.
(60) Provisional application No. 63/504,896, filed on May 30, 2023.
(60) Provisional application No. 63/590,597, filed on Oct. 16, 2023.

(51) Int. Cl. C09J 175/06; C09J 5/06; C09J 11/02; C09J 11/08; C09J 175/08

(52) U.S. Cl. CPC C09J 175/06; C09J 5/06; C09J 11/02; C09J 11/08; C09J 175/08

(57) ABSTRACT

Disclosed is a one component, hot melt polyurethane adhesive composition comprising the isocyanate functional reaction product of a polyisocyanate and a polyether polyol and/or a polyester polyol mixed with a silicone oligomer of structure 1:

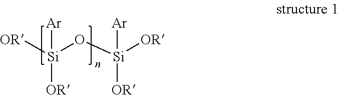

The adhesive composition has enhanced bond strength to metals such as aluminum compared to currently available adhesives. The composition finds special use in panel lamination applications.

### TECHNICAL FIELD

This disclosure relates generally to one component, reactive polyurethane hot melt adhesive compositions and more particularly to such compositions having enhanced adhesion to metal components, particularly aluminum components. The disclosure also relates to a method for improving bond strength of one component, reactive polyurethane hot melt adhesive compositions to metal substrates, particularly aluminum substrates, more particularly uncleaned mill grade aluminum substrates, and to a method of bonding composite structures comprising metal components, particularly aluminum components, using one component, reactive polyurethane hot melt adhesive compositions.

### BACKGROUND OF THE INVENTION

This section provides background information which is not necessarily prior art to the inventive concepts associated with the present disclosure.

Composite structures are widely used to make vehicles in the transportation field. Examples of such composite structures include commercial trailers, train cars, aircraft components, recreational vehicles, boats and automobiles. One conventional composite structure comprises a welded aluminum frame having a polymer skin bonded to one surface, a wood skin bonded to the opposing surface and foam between the polymer and wood skins. Curable or reactive polyurethane adhesives are typically used to bond the polymer skin to the aluminum frame and the wood skin to the aluminum frame.

Hot melt adhesives are one component adhesives that are solid at room temperature but, upon application of heat, they melt to a liquid or fluid state in which molten form they are applied to a substrate. On cooling, the adhesive regains its solid form. One class of hot melt adhesives are thermoplastic hot melt adhesives. Thermoplastic hot melt adhesives do not crosslink or cure and can be repeatedly heated to a fluid state and cooled to a solid state. Since thermoplastic hot melt adhesives do not crosslink or cure; the hard phase(s) formed upon cooling the thermoplastic hot melt adhesive imparts all of the cohesion strength, toughness, creep and heat resistance to the final adhesive. Naturally, the thermoplastic nature limits the upper temperature at which such adhesives can be used.

Another class of hot melt adhesives are curable or reactive hot melt adhesives. Reactive hot melt adhesives start out as thermoplastic materials that can be repeatedly heated to a molten state and cooled to a solid state. However, when exposed to appropriate conditions components of the reactive hot melt adhesive crosslink and cure to an irreversible solid form. One class of reactive hot melt adhesives are polyurethane hot melt adhesives. Polyurethane hot melt adhesives comprise isocyanate terminated polyurethane prepolymers that react to chain-extend, forming a new polymer. Polyurethane prepolymers are conventionally obtained by reacting polyols with isocyanates. The polyurethane prepolymers cure through the diffusion of moisture from the atmosphere or moisture on the substrates into the adhesive, and subsequent reaction of moisture with isocyanate moieties in the prepolymer. The final adhesive product is an irreversibly crosslinked material.

Reactive hot melt adhesives must be maintained at molten temperatures during use. However, even when kept under generally anhydrous conditions reactive hot melt adhesives will slowly increase in viscosity when maintained in a molten state. Eventually the equipment must be shutdown and cleaned to remove the high viscosity hot melt adhesive. In very undesirable cases the reactive hot melt adhesive can gel or phase separate in equipment during use. Either situation requires unplanned equipment shutdown, disassembly, cleaning and possibly replacement of parts that cannot be cleaned of the gelled hot melt adhesive. Reactive hot melt adhesives desirably possess heat stability, that is the ability to resist changes in viscosity over time when maintained in a molten state. Naturally, any gelling or phase separation of the reactive hot melt adhesive is considered a failure of heat stability.

Additives are commonly included in reactive hot melt adhesive formulations. However, large amounts of additives such as fillers negatively affect most reactive polyurethane hot melt adhesives and can substantially reduce the heat stability to undesirable levels. It would be desirable to provide a reactive polyurethane hot melt adhesive that includes high levels of non-fossil fuel based, sustainable, renewable additives while maintaining heat stability.

Good adhesion of the polyurethane adhesive to each of the composite components is desirable to add strength to the composite structure. Ideally, the adhesive internal strength and bond strength to a substrate will be greater than some, or all, of the substrate materials the adhesive is bonded to in order to ensure that the bonded substrate materials should fail under stress before the adhesive or adhesive bond. Additionally, water can infiltrate into a bonded composite structure. The adhesive should retain as much of the initial bond strength as possible during and after exposure to water.

To enhance adhesive bond strength manufacturers use multi-step cleaning processes of the components prior to application of adhesive and assembly into a composite structure. In a first step the metallic frame is cleaned to remove oil, grease and dirt. Next the frame is exposed to conversion coating chemicals in a bath or spray application, rinsed with water and dried. The conversion coated frame is now ready for application of adhesive and assembly into a composite structure. This process requires multiple large tanks of chemicals, lifting and drying equipment and substantial space. In a different multi step process, the metallic frame is cleaned to remove oil, grease and dirt. Next the frame is hand wiped by workers using towels saturated with conversion chemicals such as Alodine wipes from Henkel Corporation and dried. The conversion coated frame is now ready for application of adhesive and assembly into a composite structure. This method does not require the conversion coating tanks and related equipment. However, manually wiping the entire frame requires substantial effort and time and has the risk that workers can miss some areas of the frame.

It is desirable to provide a one component, hot melt polyurethane adhesive composition having increased adhesion strength to one or more composite components. It is desirable to provide a one component, hot melt polyurethane adhesive composition that has increased adhesion strength without requiring conversion coatings on the metallic components. It is desirable to provide a one component, hot melt polyurethane adhesive composition that would substantially retain the increased strength during and after exposure to water.

### SUMMARY OF THE DISCLOSURE

This section provides a general summary of the disclosure and is not a comprehensive disclosure of its full scope or all features, aspects or objectives.

In one embodiment the disclosure provides a one component, reactive polyurethane hot melt adhesive prepared from a mixture comprising at least one organic polyisocyanate, at least one polyol, a silicone oligomer and optionally other components and/or additives.

In one embodiment the disclosure is a process of bonding a skin or panel to a metal frame to form a reinforced composite structure, comprising providing a one component, reactive polyurethane hot melt adhesive composition as described in any of the embodiments; heating the one component, reactive polyurethane hot melt adhesive composition to a molten state, disposing the one component, reactive polyurethane hot melt adhesive composition on a surface of at least one of the panel or the metal frame; disposing a surface of the panel in contact with the disposed adhesive and adjacent to the surface of the metal frame; and exposing the disposed adhesive to conditions that will initiate curing. In one preferred embodiment the metal frame is aluminum and has not been treated with a conversion coating. In one preferred embodiment the metal frame is mill grade aluminum.

In one embodiment the disclosure comprises an article of manufacture including the disclosed one component, reactive polyurethane hot melt adhesive composition in cured or uncured form.

In one embodiment the compositions herein are free of silane modified polymers (SMP).

In one embodiment the disclosure comprises cured reaction products of the disclosed one component, reactive polyurethane hot melt adhesive composition.

These and other features and advantages of this disclosure will become more apparent to those skilled in the art from the detailed description of a preferred embodiment. In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in the prior art compositions or that are otherwise not necessary to the achievement of the function and/or objective of the present disclosure.

### DETAILED DESCRIPTION OF A PREFERRED EMBODIMENT

The singular forms “a”, “an” and “the” include plural referents unless the context clearly dictates otherwise.

Unless otherwise defined “about” or “approximately” used in connection with a numerical value refer to the numerical value±10%, preferably ±5% and more preferably ±1% or less.

Unless otherwise defined “%” refers to weight percent.

The term “essentially free” is intended to mean herein that the applicable group, compound, mixture or component constitutes less than 10 wt. %; typically less than 1 wt. %, preferably less than 0.5 wt. %, more preferably less than 0.1 wt. %, and ideally no more than a trace amount based on the weight of the defined composition.

Unless otherwise defined “at least one” means 1 or more, i.e., 1, 2, 3, 4, 5, 6, 7, 8, 9, or more. With reference to an ingredient, the indication refers to the type of ingredient and not to the absolute number of molecules. “At least one polymer” thus means, for example, at least one type of polymer, i.e., that one type of polymer or a mixture of several different polymers may be used.

Unless otherwise defined the terms “comprising”, “comprises” and “comprised of” as used herein are synonymous with “including”, “includes”, “containing” or “contains”, and are inclusive or open-ended and do not exclude additional, non-recited members, elements or method steps.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

An adhesive's open time refers to the time during which an adhesive can bond to a material.

As used herein preferred and preferably refer to embodiments of the disclosure that may afford particular benefits, under certain circumstances. However, the recitation of one or more preferable or preferred embodiments does not imply that other embodiments are not useful and is not intended to exclude those other embodiments from the scope of the disclosure.

Unless specifically noted, throughout the present specification and claims the term molecular weight when referring to a polymer refers to the polymer's number average molecular weight (Mn). The number average molecular weight Mₙ can be calculated based on end group analysis (OH numbers according to DIN EN ISO 4629, free NCO content according to EN ISO 11909) or can be determined by gel permeation chromatography according to DIN 55672 with THF as the eluent. If not stated otherwise, all given molecular weights are those determined by gel permeation chromatography.

Polyurethane hot melt adhesives find widespread use in panel lamination procedures. They provide good adhesion to a variety of materials and good structural bonding. Their lack of a need for a solvent, rapid green strength, and good resistance to heat, cold and a variety of chemicals make them ideal choices for use in the building industries. In one embodiment the disclosed hot melt adhesives find use in recreation vehicle panel lamination and doors. Because forming these structures can involve complex laminations it is important in these embodiments to have long open times of 6 minutes or greater and high green strength to allow positioning of components to be bonded. In addition, the final cured strength of the bonded assemblies needs to be maintained even when the assembly is exposed to temperature extremes. It is desirable to provide one component, reactive polyurethane hot melt adhesives which retain cured strength at higher temperatures than prior formulations to allow for additional uses.

The disclosed hot melt adhesives include an isocyanate functional prepolymer that is the reaction product of a mixture comprising: at least one polyol, an equivalents excess of at least one organic polyisocyanate and optionally one or more further components and/or additives. The isocyanate functionality allows the reaction product to crosslink and cure when exposed to moisture. The hot melt adhesive can comprise the isocyanate functional prepolymer, a silicone oligomer and optionally one or more of an MA-SCA, an inorganic filler, a thermoplastic polymer, a tackifier, a catalyst and additives. Preferably the hot melt adhesive is free of organic solvents, water and photoinitiators. In some preferred embodiments the prepolymer reaction product is free of silicon atoms.

Organic polyisocyanates that can be used include alkylene diisocyanates, cycloalkylene diisocyanates, aromatic diisocyanates and aliphatic-aromatic diisocyanates. Examples of isocyanates for use in the present disclosure include, by way of example and not limitation: methylenebisphenyldiisocyanate (MDI), isophorone diisocyanate (IPDI), hydrogenated methylenebisphenyldiisocyanate (HMDI), toluene diisocyanate (TDI), ethylene diisocyanate, ethylidene diisocyanate, propylene diisocyanate, butylene diisocyanate, trimethylene diisocyanate, hexamethylene diisocyanate, cyclopentylene-1, 3-diisocyanate, cyclo-hexylene-1,4-diisocyanate, cyclohexylene-1,2-diisocyanate, 4,4′-diphenylmethane diisocyanate, 2,2-diphenylpropane-4,4′-diisocyanate, xylylene diisocyanate, 1,4-naphthylene diisocyanate, 1,5-naphthylene diisocyanate, m-phenylene diisocyanate, p-phenylene diisocyanate, diphenyl-4,4′-diisocyanate, azobenzene-4,4′-diisocyanate, diphenylsulphone-4,4′-diisocyanate, 2,4-tolylene diisocyanate, dichlorohexa-methylene diisocyanate, furfurylidene diisocyanate, 1-chlorobenzene-2,4-diisocyanate, 4,4′,4″-triisocyanatotriphenylmethane, 1,3,5-triisocyanato-benzene, 2,4,6-triisocyanato-toluene, 4,4′-dimethyldiphenyl-methane-2,2′,5,5-tetratetraisocyanate, and the like.

Organic polyisocyanates having a functionality of at least three can also be used. These are the trimerization and oligomerization products of the polyisocyanates already mentioned above, such as are obtainable, with the formation of isocyanurate rings, by appropriate reaction of polyisocyanates, preferably of diisocyanates. Where oligomerization products are used, those particularly suitable have a degree of oligomerization of on average from about 3 to about 5. Isocyanates suitable for the preparation of trimers are the diisocyanates already mentioned above, particular preference being given to the trimerization products of the isocyanates HDI, MDI or IPDI. Likewise suitable for use are the polymeric isocyanates, such as are obtained, for example, as a residue in the distillation bottoms from the distillation of diisocyanates. Particularly suitable in this context is the polymeric MDI as is obtainable as a distillation residue from the distillation of MDI.

Organic polyisocyanates that can be used can include one or more isocyanate-functionalized polyurethane prepolymers. A polyurethane prepolymer is a compound such as results, for example, from the reaction of a polyol component (or other active hydrogen-functionalized compound) with an excess of at least one polyisocyanate having a functionality of at least two. The term polyurethane prepolymer embraces not only compounds having a relatively low molecular weight, such as are formed, for example, from the reaction of a polyol with an excess of polyisocyanate, but also oligomeric or polymeric compounds. Likewise embraced by the term polyurethane prepolymers are compounds formed, for example, from the reaction of a trivalent or tetravalent polyol with a molar excess of polyisocyanate, relative to the polyol. While such compounds are commercially available, methods for synthesizing such compounds are well known in the art. Preferred isocyanate-containing compounds are isomers of methylenebisphenyldiisocyanate (MDI), isophorone diisocyanate (IPDI), hydrogenated MDI (HMDI) and toluene diisocyanate (TDI).

Polyols that can be used include those polyols used for the production of polyurethanes, including, without limitation, polyether polyols, polyester polyols, polycarbonate polyols, polyacetal polyols, polyamide polyols, polyesteramide polyols, polyalkylene polyether polyols, polythioether polyols and mixtures thereof, preferably polyether polyols, polyester polyols, polycarbonate polyols and mixtures thereof.

Useful polyester polyols include those that are obtainable by reacting, in a polycondensation reaction, dicarboxylic acids with polyols. The dicarboxylic acids may be aliphatic, cycloaliphatic or aromatic and/or their derivatives such as anhydrides, esters or acid chlorides. Specific examples of these are succinic acid, glutaric acid, adipic acid, pimelic acid, suberic acid, azelaic acid, sebacic acid, dodecandioic acid, phthalic acid, terephthalic acid, isophthalic acid, trimellitic acid, phthalic acid anhydride, tetrahydrophthalic acid anhydride, glutaric acid anhydride, maleic acid, maleic acid anhydride, fumaric acid, dimeric fatty acid, dodecane dioic acid and dimethyl terephthalate. Examples of suitable polyols are monoethylene glycol, 1,2-propanediol, 1,3-propanediol, 1,4-butanediol, 3-methylpentane-1,5-diol, neopentyl glycol (2,2-dimethyl-1,3-propanediol), 1,6-hexanediol, 1,8-otaneglycol cyclohexanedimethanol, 2-methylpropane-1,3-diol, diethyleneglycol, triethyleneglycol, tetraethyleneglycol, polyethyleneglycol, dipropyleneglycol, tripropyleneglycol, tetrapropyleneglycol, polypropyleneglycol, dibutyleneglycol, tributyleneglycol, tetrabutyleneglycol and polybutyleneglycol. Alternatively, they may be obtained by ring-opening polymerization of cyclic esters, preferably caprolactone. Polyester polyols are commercially available, for example Piothane polyols available from Panolam Industries International and Dynacoll polyols available from Evonik. Other suppliers include Stepan, COIM and Lanxess. In some embodiments polyhexanediol adipate polyols are preferred.

Useful polyether polyols that can be used include linear and branched polyethers having hydroxyl groups. Examples of the polyether polyol may include a polyoxyalkylene polyol such as polyethylene glycol, polypropylene glycol, polybutylene glycol and the like. Further, a homopolymer and a copolymer of the polyoxyalkylene polyols may also be employed. Particularly preferable copolymers of the polyoxyalkylene polyols may include an adduct of at least one compound selected from the group ethylene glycol, propylene glycol, diethylene glycol, dipropylene glycol, triethylene glycol, 2-ethylhexanediol-1,3, glycerin, 1,2,6-hexane triol, trimethylol propane, trimethylol ethane, tris(hydroxyphenyl)propane, triethanolamine, triisopropanolamine, ethylenediamine and ethanolamine. Most preferably the polyether polyol comprises polypropylene glycol. Preferably the polyether polyol has a number average molecular weight of from 1,500 to 6,000 with a more preferred range of 2,000 to 4,000 Daltons. The polyether polyol may comprise a mixture of polyether polyols.

Useful polycarbonate polyols can be obtained by reaction of carbon acid derivatives, e.g., diphenyl carbonate, dimethyl carbonate or phosgene with diols. Suitable examples of such diols include ethylene glycol, 1,2- and 1,3-propanediol, 1,3- and 1,4-butanediol, 1,6-hexanediol, 1,8-octanediol, neopentyl glycol, 1,4-bishydroxymethyl cyclohexane, 2-methyl-1,3-pro-panediol, 2,2,4-trimethyl pentanediol-1,3, dipropylene glycol, polypropylene glycols, dibutylene glycol, polybutylene glycols, bisphenol A, bisphenol F, tetrabromobisphenol A as well as lactone-modified diols. In some embodiments the diol component preferably contains 40 to 100 wt. % hexanediol, preferably 1,6-hexanediol and/or hexanediol derivatives. More preferably the diol component includes examples that in addition to terminal OH groups display ether or ester groups. The polycarbonate polyols should be substantially linear. However, they can optionally be slightly branched by the incorporation of polyfunctional components, in particular low-molecular polyols. Suitable examples include glycerol, trimethylol propane, hexanetriol-1,2,6, butanetriol-1,2,4, trimethylol propane, pentaerythritol, quinitol, mannitol, and sorbitol, methyl glycoside, 1,3,4,6-dianhydrohexites.

Useful polyols further comprise polyols that are hydroxy-functionalized polymers, for example hydroxy-functionalized siloxanes as well as polyols that comprise additional functional groups, such as vinyl or amino groups.

The adhesive includes a silicone oligomer of structure 1:

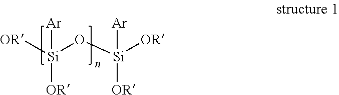

where each R′ is the same or different and is, independently from one another, selected from a hydrogen atom and hydrocarbon residues having 1 to 12 carbon atoms, preferably a methyl or ethyl group, more preferably a methyl group. Ar is selected from aryl groups, which may be linked or fused multiring aryl groups. Ar is preferably a phenyl group, n is an integer selected from 0-12, preferably 1-12. Cas Number 17938-09-9 (diphenyltetramethoxydisiloxane, n=1) is one example of a silicone oligomer of structure 1. Cas Number 2996-92-1 (phenyltrimethoxysiloxane, n=0) is one example of a silicone oligomer of structure 1. Silicone oligomers are available commercially or can be synthesized using the procedure provided in U.S. patent Ser. No. 10/800,881 to Despotopoulou et al, the contents of which are incorporated by reference.

The adhesive can optionally include an MA-SCA acid. An MA-SCA acid is a subset of multibasic acids having acidic groups connected eventually to a single central atom. Examples of MA-SCA acids include sulfuric acid, phosphonic acid, phosphoric acid, diphosphoric acid (pyrophosphoric acid). The MA-SCA acids surprisingly lengthen the time a hot melt adhesive can be maintained at operating temperature before the viscosity rises to an objectional level. Put another way, addition of an MA-SCA acid to a hot melt adhesive surprisingly decreases the rate at which that hot melt adhesive's viscosity increases when maintained at an operating temperature.

Polyurethane adhesives and sealants used at room temperature can incorporate large amounts of filler with no problem. However, adding a large amount of filler, for example 10 wt. % or more or 20 wt. % or more, to a hot melt adhesive will decrease heat stability of that hot melt adhesive, in some cases to levels that make the highly filled hot melt adhesive commercially undesirable. Adding an MA-SCA acid to a highly filled hot melt adhesive surprisingly improves heat stability of that highly filled hot melt adhesive. Although the MA-SCA acid might be expected to undesirably interact with the filler no such interactions have been seen.

The adhesive can optionally include fillers. Fillers that can be used include inorganic materials such as calcium carbonate, kaolin and dolomite. Calcium carbonate has been referred to as a non-fossil fuel based, sustainable, renewable material. Other examples of suitable fillers can be found in Handbook of Fillers, by George Wypych 3^{rd} Edition 2009 and Handbook of Fillers and Reinforcements for Plastics, by Harry Katz and John Milewski 1978. The inorganic filler is preferably present in an amount of from about 10% to about 50% by weight, more preferably from 20% to 30% by weight based on the total adhesive weight. Prior attempts to utilize large amounts of such fillers have resulted in hot melt adhesives that have short open times and issues such as undesirable increase of the molten hot melt adhesive during use.

The adhesive can optionally but preferably include tackifiers. The tackifier choices include natural and petroleum-derived materials and combinations thereof as described in: C. W. Paul, “Hot Melt Adhesives”, in Adhesion Science and Engineering—2, Surfaces, Chemistry and Applications, M. Chaudhury and A. V. Pocius eds., Elsevier, New York, 2002, p. 718. Useful tackifiers include rosin esters, aromatic hydrocarbon resins, aliphatic-modified aromatic hydrocarbon resins, phenolic-modified terpene resins, phenolic-modified aromatic resins and pure monomer resins.

The adhesive preferably does not include organosilanes as these compounds tend to destabilize the adhesive when held at use temperatures. Organosilanes may be useful in some embodiments if stability of the adhesive at working temperature is less important. Organosilanes that can be used are structurally different from the silicone oligomer of structure 1 and include amino-silanes such as a secondary amino-silane. One useful silane includes at least two silyl groups, with three methoxy groups bonded to each of the silanes hindered secondary amino groups or any combination thereof. An example of one such commercially available amino-silane is bis-(trimethoxysilylpropyl)-amine, such as Silquest A-1170. Other examples of useful organosilanes include silanes having a hydroxy functionality, a mercapto functionality, or both, such as 3-aminopropyltrimethoxysilane, 3-aminopropyltriethoxysilane, 3-aminopropyltrismethoxy-ethoxyethoxysilane, 3-aminopropy 1-methy 1-diethoxysilane, N-methyl-3-aminopropyltrimethoxysilane, N-butyl-3-aminopropyltrimethoxysilane, 3-mercaptopropyltrimethoxysilane, 3-mercaptopropyltriethoxysilane, 3-mercaptopropy1-methyl-dimethoxysilane, (N-cyclohexylaminomethyl)methyldiethoxysilane, (N-cyclohexylaminomethyl) triethoxysilane, (N-phenylaminom-ethyl)methyldimethoxysilane, (N-phenylaminomethyl) tri-methoxysilane, N-ethyl-aminoisobutyltrimethoxysilane, 4-amino-3,3-dimethylbutyltrimethoxysilane, N-(n-butyl)-3-aminopropyltriethoxysilane,N-(n-butyl)-3-aminopropylalkoxydiethoxy-silane, bis(3-triethoxysilylpropyl)amine and any combination thereof. Organosilanes are commercially available from many sources, for example Momentive Performance Materials (Silquest) and Evonik (Dynasylan). Some useful examples include Silquest Alink 15 (N-ethyl-3-trimethoxysilyl-2-methylpropanamine), Silquest Alink 35 (Gamma-isocyanatopropyltrimethoxysilane), Silquest A174NT (Gamma-methacryloxypropyltrimethoxysilane), Silquest A187 (Gamma-glycidoxypropyltrimethoxysilane), Silquest A189 (Gamma-mercaptopropyltrimethoxysilane), Silquest A 597 (Tris(3-(trimethoxysilyl)propyl)isocyanurate), Silquest A1110 (Gamma-aminopropyltrimethoxysilane), Silquest A1170 (Bis(trimethoxysilylpropyl)amine), Dynasylan 1189 (N-butyl-3-aminopropyltrimethoxysilane), Silquest A1289 (bis-(triethoxysilylpropyletrasulfide), and Silquest Y9669 (N-phenyl-gamma-aminopropyltrimethoxysilane).

The adhesive can optionally but preferably include thermoplastic polymers or copolymers such as acrylic or EVA. The thermoplastic polymers can be functional, having moieties such as active hydrogen atoms, hydroxyl, amino or (meth)acrylate that can be reactive with other components in the adhesive, or can be non-functional. Acrylic polymers that can be used include acrylic polymers formed from acrylates, methacrylates and mixtures thereof as known in the art and acrylic copolymers comprising at least one of methyl methacrylate monomers and n-butyl methacrylic monomers. Examples of these acrylic copolymers include Elvacite® 2013, which is a methyl methacrylate and n-butyl methacrylate copolymer having a weight average molecular weight of 34,000; Elvacite® 2016, which is a methyl methacrylate and n-butyl methacrylate copolymer having a weight average molecular weight of 60,000; and Elvacite® 4014 which is copolymer of methyl methacrylate, n-butyl methacrylate and hydroxyethyl methacrylate and has a weight average molecular weight of 60,000. The Elvacite® polymers are available from Lucite International. Additional examples of suitable acrylic polymers can be found in U.S. Pat. Nos. 6,465,104 and 5,021,507 herein incorporated by reference. Preferably the acrylic polymer has a weight average molecular weight of from 8,000 to 150,000, more preferably from 25,000 to 100,000. It is preferably present in an amount of from about 5% to 40% by weight, more preferably from 10% to 30% by weight based on the total adhesive weight. The acrylic polymer preferably has an OH number of less than 8, more preferably less than 5. The acrylic polymer preferably has a glass transition temperature Tg of from about 35 to about 85° C., more preferably from 45 to 75° C.

EVA copolymers are copolymers of ethylene and vinyl acetate. The two monomers can be copolymerized in any quantity ratio. The copolymers obtained are characterized by a statistical distribution of the monomer units in the polymer chains and the properties of the EVA copolymers may be varied within wide limits through the molar ratio of ethylene to vinyl acetate. For example, products with an ethylene content of less than 30% by weight are partly crystalline and thermoplastic while products with a vinyl acetate content of about 40 to about 70% by weight are substantially amorphous. The EVA copolymers are generally produced by bulk, emulsion or solution polymerization. The molecular weight of the EVA copolymers used in accordance with the invention is in the range from about 10,000 to about 1,500,000. The vinyl acetate content in the EVA copolymers used in accordance with the invention is in the range of 9% to 70% by weight and preferably in the range of 20% to 55% by weight. Examples of suitable ethylene/vinyl acetate copolymers included the commercial ELVAX products available from Dow which have vinyl acetate contents of from about 27 to 42% by weight. In addition, other monomers can also be incorporated with the EVA copolymers for desirable properties, including isocyanate-reactive functional groups.

The adhesive can optionally include catalyst conventionally used with polyurethane reactions. Some useful catalysts include, for example 2,2′-dimorpholinodiethylether, triethylenediamine, dibutyltin dilaurate and stannous octoate. A preferred catalyst is 2,2′-dimorpholinodiethylether (DMDEE).

The composition can optionally comprise at least one filler selected from inorganic fillers such as calcium carbonate, powdered limestone, precipitated and/or pyrogenic silica, zeolites, bentonites, magnesium carbonate, kieselguhr, alumina, clay, tallow, titanium oxide, iron oxide, zinc oxide, sand, quartz, flint, mica, powdered glass, ground minerals; organic fillers such as carbon black, graphite, wood fibers, wood flour, sawdust, cellulose, cotton, pulp, wood chips, chopped straw, chaff, ground walnut shells; short-cut fibers such as glass fibers, glass filament, polyacrylonitrile fibers, carbon fibers, Kevlar fibers, polyethylene fibers; and hollow spheres with a mineral shell or a plastic shell such as hollow glass spheres commercially available as Glass Bubbles® and plastic hollow spheres commercially available as Expancel® or Dualite®. These hollow sphere fillers are composed of inorganic or organic substances, each with a diameter of 1 mm or less, preferably of 500 μm or less. In one embodiment calcium carbonate can be used as a filler as this can be considered a sustainable, renewable, non-fossil fuel filler.

The adhesive can optionally include one or more of a variety of known hot melt adhesive additives such as plasticizer, colorant, rheology modifier, flame retardant, UV pigment, nanofiber, defoamer, anti-oxidant, stabilizer, a thixotropic agent such as fumed silica, and the like. Conventional additives that are compatible with a composition according to this invention may simply be determined by combining a potential additive with the composition and determining if they are compatible. An additive is compatible if it is homogenous within the product at room temperature and at the use temperature.

In one embodiment the hot melt adhesive comprises a reaction product of a mixture comprising:

| | | narrower | preferred |
|---|---|---|---|
| | range | range | range |
| | (wt. %) | (wt. %) | (wt. %) |
| prepolymer | | | |
| polyisocyanate | 3-35 | 5-30 | 5-20 |
| polyether polyol | 0-70 | 5-60 | 20-50 |
| polyester polyol | 0-70 | 3-60 | 5-50 |
| composition | | | |
| silicone oligomer | 0.01-10 | 0.05-3 | 0.1-2 |
| content | | | |
| silicone oligomer | n = 0-12 | n = 1-12 | 1-8 |
| chain length | | | |
| inorganic filler | 0-70 | 0-50 | 0-30 |
| thermoplastic polymer | 0-50 | 10-40 | 15-35 |
| catalyst | 0-1 | 0.01-1 | 0.02-0.5 |
| MA-SCA acid | 0 to <1,000 ppm | 0 to <800 ppm | <600 ppm |
| organosilane | 0-5 | 0-1 | 0 |
| tackifier | 0-50 | 2-35 | 5-25 |
| additives | 0-50 | 0-35 | 0-25 |

Typically, the adhesive composition can comprise 30 to 99.9% polyurethane prepolymer reaction product and more preferably 50 to 99.9% polyurethane prepolymer reaction product.

The disclosed hot melt adhesives can be prepared using the following procedure. Note that moisture must be excluded from the polyurethane reaction. The polyols, any thermoplastic polymer and any filler are added to a reactor and placed under heat and vacuum to remove moisture. Once dried, an excess of polyisocyanate is added to the reactor which is maintained under heat and an inert gas barrier to exclude moisture. After suitable reaction time the silicone oligomer and optionally catalyst can be added to the reaction product and mixed in. The final product comprises an isocyanate functional prepolymer mixed with the remaining components and is transferred to a moisture proof container and sealed immediately. Optional components and additives, if used, can be added with the polyols or after reaction. Drying of the optional components may be required to prevent reaction with the isocyanate moieties in the adhesive composition.

The hot melt adhesives according to the present disclosure can be applied in a variety of manners including by spraying, roller coating, extruding and as a bead. The disclosed hot melt adhesive is stable during storage as long as moisture is excluded. It can be applied to a range of substrates including metal, wood, plastic, glass and textile.

The hot melt adhesives according to the present disclosure will not gel or separate into phases when held at temperatures and for times used in commercial application equipment, for example the hot melt adhesive can be maintained at 121° C. for 24 hours. In some embodiments the disclosed hot melt adhesives have a viscosity increase of 500% or less, preferably 200% or less and more preferably 100% or less when held at temperatures and for times used in commercial application equipment. Holding samples at 121° C. for 24 hours in a sealed container (e.g., excluding air and moisture) was used to approximate commercial conditions.

The invention also provides a method for bonding articles together which comprises providing the reactive hot melt adhesive in cooled, typically solid, form; heating the reactive hot melt adhesive to a molten form; applying the molten reactive hot melt adhesive composition in molten form to a first article; bringing a second article in contact with the composition applied to the first article; allowing the adhesive to cool and solidify; and subjecting the applied composition to conditions which will allow the composition to fully cure to a composition having an irreversible solid form, the conditions comprising moisture. The hot melt adhesive is typically distributed and stored in its solid form and in the absence of moisture to prevent curing during storage. The composition is heated to a molten form prior to application and applied in the molten form. Typical application temperatures are in the range of from about 80° C. to about 145° C., typically about 120° C. Thus, this disclosure includes reactive polyurethane hot melt adhesive compositions in both its uncured, solid form, as it is typically stored and distributed, its molten form after it has been melted just prior to its application and in its irreversibly solid form after curing.

After application, to adhere articles together, the reactive hot melt adhesive composition is subjected to conditions that will allow it to solidify and cure to a composition that has an irreversible solid form. Solidification or setting occurs when the liquid melt begins to cool from its application temperature to room temperature. Curing, i.e., chain extending, to a composition that has an irreversible solid form, takes place in the presence of ambient moisture.

The disclosed reactive polyurethane hot melt adhesive compositions are particularly suited for use as an adhesive in reinforced composite structures. One example is the large reinforced composite panels used in making recreational vehicles. Such reinforced composite panels typically include one or two panels or “skins” laminated to opposing sides of a reinforcing metal frame. The skins can comprise, for example, wood or wood products, plastics, fiber reinforced plastics (FRP), metals or metal foils, high pressure laminate (HPL) skins, or other materials. Typically the exterior skin is plastic or plastic composite to resist weathering. If an internal skin is desired, it is typically wood or laminated wood such as Lauan plywood. The frame typically comprises a plurality of tubular metal sections that are welded together to form a structural frame. Generally, the tubular metal sections have a quadrilateral cross-sectional shape with bonding surfaces defined on opposing sides of the shape. Structural aluminum pieces are used in recreational vehicles almost exclusively to lessen weight of the frame and vehicle. Materials such as expanded polystyrene (EPS) foam sheet can be disposed between the skins in space not taken by the frame. A panel lamination process includes: disposing a one component, hot melt polyurethane adhesive in molten form on some of the surfaces to be laminated; optionally misting with water to accelerate curing; placing the skin or skins in contact with adhesive disposed on the frame surfaces; moving the assembled parts through a nip press to apply pressure to the assembled parts and stacking the assembled parts and routing or stocking of the parts after the initial setting and/or cure of the adhesive. The disclosed one component, reactive polyurethane hot melt adhesive compositions provide enhanced bond strength to the aluminum frame, especially an untreated aluminum frame, compared to conventional adhesives.

For reinforced composite panels used in vehicles it is desired to have a % adhesion of at least about 30%, preferably at least about 50%, more preferably at least about 70% and most preferably at least about 90%. An adhesion % of 100% would be ideal as it denotes the substrate fails before the adhesive bond. While some of these adhesion strengths can be achieved with conventional reactive polyurethane hot melt adhesives in combination with anodized or conversion coated aluminum frame members it has not been possible to consistently achieve even the 30% adhesion strength using conventional reactive polyurethane hot melt adhesives with mill grade aluminum frame members, e.g. untreated aluminum frame members as received from a mill with no cleaning and no conversion coating or anodizing.

### Experimental Data

Viscosity of the products, in centipoise (cP), was measured on a Brookfield DV-1+viscometer with a heated sample cup and using a #27 spindle at 121° C. after 30 minutes equilibration at temperature.

Heat stability was measured using the following aging test. An uncured polyurethane hot melt adhesive is filled into an aluminum tube and the tube is sealed to exclude air and moisture. The tube and sample is thermally aged in an oven at 121 C for 24 hours. After aging the sample viscosity is measured by using Brookfield viscometer (#27 spindle) before and after the thermal aging and the percentage viscosity increase is recorded. Excluding air and moisture helps prevent reaction of the aging sample with moisture. The aging test is an approximation of how the hot melt adhesive will react when held at molten temperatures over time as would occur during use. Viscosity change is defined as:

$$( final viscosity - initial v iscosity ) / final viscocity$$

If the sample after thermal aging is gelled or phase separated the viscosity after aging is not measured and the thermal stability is considered to be unacceptable and a failure.

NCO % was monitored using a Brinkman Metrohm automatic titrator.

% adhesion was tested by applying the test composition to an untreated piece of mill grade, hollow rectangular aluminum tubing at an effective coating weight of 10 to 12 grams per square foot (gsf). The mill grade aluminum was used as received, it was not cleaned or anodized or conversion coated before testing. A piece of Lauan plywood (approximately 3 mm thick) was disposed over the applied adhesive and vacuum pressed onto the adhesive and tubing for 1 hour. The laminate was allowed to cure for two days at room temperature and ambient moisture conditions. Adhesion of Lauan plywood to aluminum was tested by attempting to pry the plywood off of the tubing using a spatula. The percentage of Lauan plywood failure was visually assessed based on the amount of wood remaining bonded to the aluminum e.g., 90% adhesion means 90% of the wood remains bonded (a good result) while 10% adhesion means 10% of the wood remains bonded (a failing result). The results were recorded. Uncertainty range for the % adhesion is about + or −5%.

### Silicone Oligomers.

The silicone oligomers are commercially available. Alternatively, the silicone oligomers can be synthesized.

Synthesis of Diphenyltetramethoxydisiloxane (n=1 in Formula 1)

Phenyltrimethoxysilane (195.2 g) can be placed in a 3 neck round bottom flask (0.5 L) equipped with a magnetic stirring bar a thermometer and a dropping funnel. 1 N Hydrochloric acid (8.8 g with a molar ratio of water:methoxy 6:1) can be added dropwise to the silane over a period of 7 h, whereby the temperature of the mixture is not allowed to exceed 40° C. The mixture can be left stirring for 10 h after which the reaction was stopped and the mixture stored at 25° C. for at least one day prior to distillation. Purification of the reaction mixture occurred via vacuum distillation. At a vacuum of 1 mbar two fractions were isolated. The first fraction came at 130° C. and contained unreacted phenyltrimethoxysilane. The second fraction was isolated at 230° C. and contained the desired product 1,2-diphenyltetramethoxydisiloxane (36% yield).

The following materials were used in the Examples.

| | |
|---|---|
| PPG2000 | A polypropylene glycol, number average molecular weight |
| | of 2,000 from Covestro. |
| PPG4000 | A polypropylene glycol, number average molecular weight |
| | of 4,000 from Covestro. |
| Polyester polyol | Poly hexamethylene adipate diol (HD/AA) with a number- |
| | average MW of 3,500 and acid number = 1.12 |
| Polyester polyol-2 | A liquid polyester of C₂-C₅ and C₆ diols, adipic acid with a |
| | number-average molecular weight of 5,500 and hydroxyl |
| | number = 20 |
| Polyester polyol-3 | A liquid polyester of C₆ diol, adipic, isophthalic acids with a |
| | number-average molecular weight of 2,000 and hydroxyl |
| | number = 57.8 |
| Elvax 210 | An ethylene-vinyl acetate copolymer resin with vinyl |
| | acetate content of 28%, from Dupont. |
| Kristalex 3100 | A tackifier of hydrocarbon resin type, from Eastman |
| | Chemical Company |
| Foralyn 5020F | A hydrogenated rosin tackifier from Eastman Chemical |
| | Company |
| Sylvares SA 100 | An aromatic hydrocarbon resin tackifier from Arizona |
| | Chemical |
| silicone oligomer (n = 1) | 1,3 diphenyltetramethoxydisiloxane - (n = 1 in formula 1); |
| | CAS# 17938-09-9 |
| silicone oligomer (n = 0) | Phenyltrimethoxysilane - (n = 0 in formula 1); CAS# 2996- |
| | 92-1 |
| Silquest A-1110 | An amino silane from Momentive Performance Materials |

The Examples were prepared as shown below. Amounts are in parts by weight based on the weight of the entire composition.

Examples were prepared as described below. In each case the materials are moisture reactive so the reactions, packaging and storage were done under conditions to exclude moisture.

### Example 1—Comparative

185 parts of PPG2000 and 185 parts of PPG4000, were introduced into a heatable stirred tank reactor with a vacuum connection and 165 parts of Elvacite 2016, 115 parts of Elvax 210, 115 parts of Kristalex 3100, and 140 parts of polyester polyol, were blended and melted therein. Moisture was then removed under vacuum over a period of 2 hours at 121° C. The reactor was then purged with nitrogen, 88.2 parts of 4,4′-diphenylmethane-diisocyanate (MDI) were added and the contents of the reactor were stirred for 15 minutes under nitrogen at 121° C., and then 2 hours under vacuum at 121° C. The reactor was purged with nitrogen, 1.5 parts of 2,2′-dimorpholinildiethylether (DMDEE) were added and stirred for 15 minutes under nitrogen. The product was then transferred to a moisture proof container and sealed immediately for later test.

### Example 2—Inventive

185 parts of PPG2000 and 185 parts of PPG4000, were introduced into a heatable stirred tank reactor with a vacuum connection and 165 parts of Elvacite 2016, 115 parts of Elvax 210, 115 parts of Kristalex 3100, and 140 parts of polyester polyol, were blended and melted therein. Moisture was then removed under vacuum over a period of 2 hours at 121° C. The reactor was then purged with nitrogen, 88.2 parts of 4,4′-diphenylmethane-diisocyanate (MDI) were added and the contents of the reactor were stirred for 15 minutes under nitrogen at 121° C., and then 2 hours under vacuum at 121° C. The reactor was purged with nitrogen, 1.5 parts of 2,2′-dimorpholinildiethylether (DMDEE), 0.3 parts of 85% phosphoric acid, and 5 parts of 1,3 diphenyltetramethoxydisiloxane, were added and stirred for 15 minutes under nitrogen. The product was then transferred to a moisture proof container and sealed immediately for later test.

### Example 3—Inventive

185 parts of PPG2000 and 185 parts of PPG4000, were introduced into a heatable stirred tank reactor with a vacuum connection and 165 parts of Elvacite 2016, 115 parts of Elvax 210, 115 parts of Kristalex 3100, and 140 parts of polyester polyol, were blended and melted therein. Moisture was then removed under vacuum over a period of 2 hours at 121° C. The reactor was then purged with nitrogen, 88.2 parts of 4,4′-diphenylmethane-diisocyanate (MDI) were added and the contents of the reactor were stirred for 15 minutes under nitrogen at 121° C., and then 2 hours under vacuum at 121° C. The reactor was purged with nitrogen, 1.5 parts of 2,2′-dimorpholinildiethylether (DMDEE) and 5 parts of 1,3 diphenyltetramethoxydisiloxane, were added and stirred for 15 minutes under nitrogen. The product was then transferred to a moisture proof container and sealed immediately for later test.

### Example 4—Inventive

185 parts of PPG2000 and 185 parts of PPG4000, were introduced into a heatable stirred tank reactor with a vacuum connection and 165 parts of Elvacite 2016, 115 parts of Elvax 210, 115 parts of Kristalex 3100, and 140 parts of polyester polyol, were blended and melted therein. Moisture was then removed under vacuum over a period of 2 hours at 121° C. The reactor was then purged with nitrogen, 88.2 parts of 4,4′-diphenylmethane-diisocyanate (MDI) were added and the contents of the reactor were stirred for 15 minutes under nitrogen at 121° C., and then 2 hours under vacuum at 121° C. The reactor was purged with nitrogen, 1.5 parts of 2,2′-dimorpholinildiethylether (DMDEE), 0.3 parts of 85% phosphoric acid, and 5 parts of phenyltrimethoxysilane, were added and stirred for 15 minutes under nitrogen. The product was then transferred to a moisture proof container and sealed immediately for later test.

### Example 5—Comparative

185 parts of PPG2000 and 185 parts of PPG4000, were introduced into a heatable stirred tank reactor with a vacuum connection and 165 parts of Elvacite 2016, 115 parts of Elvax 210, 115 parts of Kristalex 3100, and 140 parts of polyester polyol, were blended and melted therein. Moisture was then removed under vacuum over a period of 2 hours at 121° C. The reactor was then purged with nitrogen, 88.2 parts of 4,4′-diphenylmethane-diisocyanate (MDI) were added and the contents of the reactor were stirred for 15 minutes under nitrogen at 121° C., and then 2 hours under vacuum at 121° C. The reactor was purged with nitrogen, 1.5 parts of 2,2′-dimorpholinildiethylether (DMDEE), 0.3 parts of 85% phosphoric acid, and 5 parts of A-1110, were added and stirred for 15 minutes under nitrogen. The product was then transferred to a moisture proof container and sealed immediately for later test.

### Example 6—Comparative

185 parts of PPG2000 and 185 parts of PPG4000, were introduced into a heatable stirred tank reactor with a vacuum connection and 165 parts of Elvacite 2016, 115 parts of Elvax 210, 115 parts of Kristalex 3100, and 140 parts of polyester polyol, were blended and melted therein. Moisture was then removed under vacuum over a period of 2 hours at 121° C. The reactor was then purged with nitrogen, 88.2 parts of 4,4′-diphenylmethane-diisocyanate (MDI) were added and the contents of the reactor were stirred for 15 minutes under nitrogen at 121° C., and then 2 hours under vacuum at 121° C. The reactor was purged with nitrogen, 1.5 parts of 2,2′-dimorpholinildiethylether (DMDEE) and 5 parts of A-1110, were added and stirred for 15 minutes under nitrogen. The product was then transferred to a moisture proof container and sealed immediately for later test.

### Example 7—Inventive

185 parts of PPG2000 and 185 parts of PPG4000, were introduced into a heatable stirred tank reactor with a vacuum connection 185 parts of polyester polyol, were blended and melted therein. Moisture was then removed under vacuum over a period of 2 hours at 121° C. The reactor was then purged with nitrogen, 50 parts of 4,4′-diphenylmethane-diisocyanate (MDI) were added and the contents of the reactor were stirred for 15 minutes under nitrogen at 121° C., and then 2 hours under vacuum at 121° C. The reactor was purged with nitrogen, 1.5 parts of 2,2′-dimorpholinildiethylether (DMDEE) and 5 parts of 1,3 diphenyltetramethoxydisiloxane, were added and stirred for 15 minutes under nitrogen. The product was then transferred to a moisture proof container and sealed immediately for later test.

### Example 8—Inventive

185 parts of PPG 2000 and 185 parts of PPG 4000 were introduced into a heatable stirred tank reactor with a vacuum connection and 165 parts of Elvacite 2016, 115 parts of Elvax 210, 115 parts of Foralyn 5020F, and 140 parts of polyester polyol, were blended and melted therein. Moisture was then removed under vacuum over a period of 2 hours at 121° C. The reactor was then purged with nitrogen, 88.2 parts of 4,4′-diphenylmethane-diisocyanate (MDI) were added and the contents of the reactor were stirred for 15 minutes under nitrogen at 121° C., and then 2 hours under vacuum at 121° C. The reactor was purged with nitrogen, 1.5 parts of 2,2′-dimorpholinildiethylether (DMDEE) and 5 parts of 1,3 diphenyltetramethoxydisiloxane, were added and stirred for 15 minutes under nitrogen. The product was then transferred to a moisture proof container and sealed immediately for later test.

### Example 9—Inventive

185 parts of PPG 2000 and 185 parts of PPG 4000 were introduced into a heatable stirred tank reactor with a vacuum connection and 165 parts of Elvacite 2016, 115 parts of Elvax 210, 115 parts of Sylvares SA 100, and 140 parts of polyester polyol, were blended and melted therein. Moisture was then removed under vacuum over a period of 2 hours at 121° C. The reactor was then purged with nitrogen, 88.2 parts of 4,4′-diphenylmethane-diisocyanate (MDI) were added and the contents of the reactor were stirred for 15 minutes under nitrogen at 121° C., and then 2 hours under vacuum at 121° C. The reactor was purged with nitrogen, 1.5 parts of 2,2′-dimorpholinildiethylether (DMDEE) and 5 parts of 1,3 diphenyltetramethoxydisiloxane, were added and stirred for 15 minutes under nitrogen. The product was then transferred to a moisture proof container and sealed immediately for later test.

### Example 10—Inventive

255 parts of PPG2000 and 255 parts of PPG4000, were introduced into a heated stirred tank reactor with a vacuum connection and 165 parts of Elvacite 2016, 115 parts of Elvax 210, and 115 parts of Kristalex 3100, were blended and melted therein. Moisture was then removed under vacuum over a period of 2 hours at 121° C. The reactor was then purged with nitrogen, 80.2 parts of 4,4′-diphenylmethane-diisocyanate (MDI) were added and the contents of the reactor were stirred for 15 minutes under nitrogen at 121° C., and then 2 hours under vacuum at 121° C. The reactor was purged with nitrogen, 1.5 parts of 2,2′-dimorpholinildiethylether (DMDEE) and 5 parts of 1,3 diphenyltetramethoxydisiloxane, were added and stirred for 15 minutes under nitrogen. The reaction product was then transferred to a moisture proof container and sealed immediately for later test.

### Example 11—Inventive

106 parts of polyester—2 and 264 parts of polyester—3, were introduced into a heated stirred tank reactor with a vacuum connection and 165 parts of Elvacite 2016, 115 parts of Elvax 210, 115 parts of Kristalex 3100, and 140 parts of polyester polyol, were blended and melted therein. Moisture was then removed under vacuum over a period of 2 hours at 121° C. The reactor was then purged with nitrogen, 84.2 parts of 4,4′-diphenylmethane-diisocyanate (MDI) were added and the contents of the reactor were stirred for 15 minutes under nitrogen at 121° C., and then 2 hours under vacuum at 121° C. The reactor was purged with nitrogen, 1.5 parts of 2,2′-dimorpholinildiethylether (DMDEE) and 5 parts of 1,3 diphenyltetramethoxydisiloxane, were added and stirred for 15 minutes under nitrogen. The reaction product was then transferred to a moisture proof container and sealed immediately for later test.

| | | | | | Adhesion |
|---|---|---|---|---|---|
| | | | | Viscosity | (Wood |
| | | Original | Final | Change | Substrate |
| Ex. | Additives | Viscosity | Viscosity | (%) | Failure) |
| 1 comp | none | 9600 | 13100 | 36 | 5% |
| 2 inv | 1,3 | 11000 | 20680 | 88 | 95% |
| | diphenyltetramethoxydisiloxane | | | | |
| | phosphoric acid | | | | |
| 3 inv | 1,3 | 10100 | 20750 | 105 | 95% |
| | diphenyltetramethoxydisiloxane | | | | |
| 4 inv | Phenyltrimethoxysilane | 12300 | 21500 | 75 | 55% |
| | phosphoric acid | | | | |
| 5 comp | A-1110 phosphoric acid | 12400 | 59520 | 380 | 95% |
| 6 comp | A-1110 | 13800 | gelled | N/A | 95% |
| 7 inv | 1,3 | 7500 | 11500 | 53 | 50% |
| | diphenyltetramethoxydisiloxane | | | | |
| 8 inv | 1,3 | 5600 | 8050 | 44 | 95% |
| | diphenyltetramethoxydisiloxane | | | | |
| 9 inv | 1,3 | 8900 | 17700 | 99 | 75% |
| | diphenyltetramethoxydisiloxane | | | | |
| 10 inv | 1,3 | 11500 | 24150 | 110 | 95% |
| | diphenyltetramethoxydisiloxane | | | | |
| 11 inv | 1,3 | 12000 | 27600 | 130 | 95% |
| | diphenyltetramethoxydisiloxane | | | | |

As shown by the results in the above Table:
Example 1 shows a conventional polyurethane reactive hot melt adhesive, can have good stability under heat but it has very poor adhesion to untreated aluminum substrates.
Example 7 shows that a polyurethane reactive hot melt containing the disclosed silicon oligomer (1,3-diphenyltetromethoxydisiloxane, n=1 in formula 1) can have both good adhesion to untreated aluminum substrates and good stability under heat. Please note that Example 7 does not contain Elvax 210, Kristalex 3100, or Elvacite 2016.
Examples 5 and 6 show a polyurethane reactive hot melt adhesive containing the right silane can have improved adhesion to untreated aluminum frames (the wood substrate failed before the adhesive to aluminum substrate bond). However, the stability under heat is not as good as desired and can even unacceptably gel during use.
Example 4 shows a polyurethane reactive hot melt adhesive containing the disclosed silicon oligomer (phenyltrimethoxysilane, n=0 in formula 1) can have both good adhesion to untreated aluminum substrates and good stability under heat.
Example 3 shows a polyurethane reactive hot melt adhesive containing the disclosed silicon oligomer (1,3-diphenyltetromethoxydisiloxane, n=1 in formula 1) can have both excellent adhesion to untreated aluminum substrates and good stability under heat.
Example 2 shows a polyurethane reactive hot melt adhesive containing both the disclosed silicon oligomer (1,3-diphenyltetromethoxydisiloxane, n=1 in formula 1) and MA-SCA can have both excellent adhesion to untreated aluminum substrates and even better stability under heat compared to Example 3 without the MA-SCA.

Most of the inventive Examples used a combination of polyether and polyester polyols with excellent results. Examples 10 and 11 show that a polyurethane reactive hot melt adhesive comprising only polyether polyol or only polyester polyol can also provide excellent results.

The above testing focused on improved adhesion of the disclosed polyurethane reactive hot melt adhesives on aluminum substrate. A further set of tests were run using the adhesive of Example 2 on uncleaned stainless steel substrates. These tests used the same testing protocol as in the previous testing of aluminum substrates. Six tests were conducted, yielding an average of 45% for the wood substrate failure percentage. These tests show the disclosed polyurethane reactive hot melt adhesives can improve adhesion strength to stainless steel substrates.

The results show that introducing a specific group of silicone oligomers and optionally MA-SCA acids into a specific polyurethane reactive hot melt adhesive can provide a reactive polyurethane hot melt adhesive which delivers excellent adhesion to untreated metals while maintaining good stability under heat.

The terminology used herein is for the purpose of describing particular example embodiments only and is not intended to be limiting. The method steps, processes, and operations described herein are not to be construed as necessarily adding requiring their performance in the particular order discussed or illustrated, unless specifically identified as an order of performance. It is also to be understood that additional or alternative steps may be employed.

We claim:

1. A one component, reactive polyurethane hot melt adhesive, comprising:
an isocyanate functional prepolymer reaction product of a mixture including at least one polyisocyanate and at least one polyol;
a silicone oligomer of structure 1: 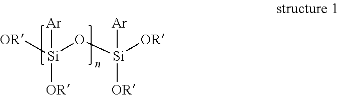
wherein each R′ is the same or different and is, independently from one another, selected from a hydrogen atom or a hydrocarbon residue having 1 to 12 carbon atoms, Ar is selected from aryl groups; and n is an integer selected from 0-12.

2. The one component, reactive polyurethane hot melt adhesive of claim 1, wherein the polyol in the mixture comprises a polyether polyol, a polyester polyol, or a combination of a polyether polyol and a polyester polyol; and wherein the silicone oligomer Ar group is a phenyl group and R′ is a methyl or ethyl group.

3. The one component, reactive polyurethane hot melt adhesive of claim 1, wherein the polyol in the mixture comprises a first polyether polyol having a molecular weight, a second polyether polyol having a molecular weight different from the first polyether polyol and a polyester polyol.

4. The one component, reactive polyurethane hot melt adhesive of claim 1, wherein the isocyanate functional prepolymer is free of Si atoms.

5. The one component, reactive polyurethane hot melt adhesive of claim 1, further comprising at least one of 10 to 50 wt. % of an inorganic filler or up to 1 wt. % of an MA-SCA acid.

6. The one component, reactive polyurethane hot melt adhesive of claim 1, further comprising one or more of a thermoplastic resin, a tackifier or a catalyst.

7. The one component, reactive polyurethane hot melt adhesive of claim 1, further comprising a thermoplastic resin selected from an acrylic resin, an EVA resin, and a tackifier.

8. The one component, reactive polyurethane hot melt adhesive of claim 1, further comprising an MA-SCA acid selected from nitric acid, sulfuric acid, phosphonic acid, phosphoric acid, diphosphoric acid (pyrophosphoric acid) and combinations thereof, present in an amount of up to 1 wt. %.

9. The one component, reactive polyurethane hot melt adhesive of claim 1, wherein cured reaction products of the adhesive have a % adhesion of at least 50.

10. A method of making a bonded reinforced composite structure, comprising:
providing an aluminum frame having a first bonding surface;
providing a first panel having a bonding surface;
providing a one component, reactive polyurethane hot melt adhesive, wherein the adhesive composition comprises an isocyanate functional prepolymer reaction product of a mixture including at least one polyisocyanate and at least one polyol; and
a silicone oligomer of structure 1: 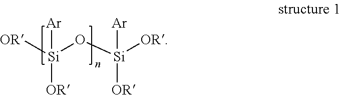
wherein each R′ is the same or different and is, independently from one another, selected from a hydrogen atom or a hydrocarbon residue having 1 to 12 carbon atoms, R′ is a methyl or ethyl group, Ar is a phenyl group; and n is an integer selected from 0-12;
heating the adhesive to a molten state;
applying the molten adhesive on at least one bonding surface;
disposing the first panel bonding surface in contact with the disposed adhesive and frame bonding surface to form a composite structure; and
curing the adhesive to bond the first panel to the metal frame.

11. The method of claim 10, wherein:
the aluminum frame has a quadrilateral cross section and a second bonding surface opposing the first bonding surface; and comprising:
providing a second panel having a bonding surface;
applying the adhesive on at least one of the frame second bonding surface or the second panel bonding surface;
disposing the second panel bonding surface in contact with the disposed adhesive and frame second bonding surface; and
curing the adhesive to bond the second panel to the metal frame.

12. The method of claim 10, wherein at least one aluminum bonding surface is mill grade with no cleaning.

13. The method of claim 10, wherein at least one aluminum bonding surface has no surface conversion coating and/or anodizing.

14. The method of claim 10, wherein at least one aluminum bonding surface is conversion coated.

15. The method of claim 10, wherein the first panel comprises a cured polymer and/or plywood.

16. The method of claim 10, wherein the composite structure is free of mechanical fasteners to hold the first panel to the frame.

17. The method of claim 10, further comprising disposing insulation in a void area defined by the frame and first panel bonding surface.
